(19) United States
(12) Patent Application Publication
(10) Pub. No.: US 2005/0274216 A1
(43) Pub. Date: Dec. 15, 2005

(54) Enveloping speed reducer

(76) Inventor: Yakov Fleytman, Lake Orion, MI (US)

Correspondence Address: YAKOV FLEYTMAN, 3233 HICKORY DRIVE, LAKE ORION, MI, 48359, US

(21) Appl. No.: 10/854,363

(22) Filed: May 27, 2004

(51) Int. Cl. F16H 1/16

(52) U.S. Cl. 74/457

(57) ABSTRACT

A speed reducer is provided with housing having bearing support for a shaft of an enveloping worm and a shaft of a face gear. The enveloping worm placed into meshing engagement with the face gear. They have crossing, intersected or parallel axes. The enveloping worm face gears are used for mechanical power transition while reducing the noise and the weight of the speed reducer.

### FIELD OF THE INVENTION

The present invention relates generally to gears reducers, and more particularly, to gears box having an enveloping or globoid worm in mesh with a mating gear. This type of speed reducer could be used in industrial applications, medical devices, and any mechanical power reduction systems.

### BACKGROUND OF THE INVENTION

Enveloping worm speed reducers, particular double enveloping worm gear drive are used in various applications as a high ratio, more than 5:1 of mechanical drive. In double enveloping speed reducer a pinion shaft and mating worm gear shafts are crossed. (U.S. Pat. No. 1,980,237 by Trbojevich, U.S. Pat. No. 5,836,076 by Duta and Prom, U.S. Pat. No. 5,018,403 by Umezono and Maki.). Due to high ratios, it has been considered impractical to use the worm gear as the driven member and the worm as the driving member to transfer power from the worm gear to the worm. Most efficient and practical use of enveloping worm in lower ratio applications is drive axle assemble with enveloping worm described in my U.S. Pat. No. 6,537,174 and power take-off unit described in my U.S. Pat. No. 6,523,430.

The distance between axis of enveloping worm rotation and axis of worm gear rotation can not allow the use of above described enveloping worm in mesh with enveloping type worm gear in existing speed reducers, by substituting spiral bevel or helical gears. Spiral bevel gears have zero offset and hypoid gear set compared to double enveloping worm drive also has a very small offset, and helical gear sets are gears with parallel shafts.

### SUMMARY OF THE INVENTION

Accordingly, it is an object of the present invention to provide a speed reducer with wide range of ratios, even with ratio less than 5:1. It is a further object of the present invention to be able to substitute existing speed reducers using spiral bevel, hypoid or helical gears, where input and output shafts are intersected, crossed or parallel.

These and other objects of the present invention are obtained by providing a speed reducer with a unique enveloping worm face gearset. In particular, an enveloping-type worm mounted thereto is meshed with a face type worm gear, where face worm gear teeth having a tooth surface is generated by a profile of the enveloping worm.

Enveloping worm or globoid worm face gear transmissions have not been known. Thus, those skilled in the art did not consider enveloping type worm gears in mesh with a face type worm gear to be feasible for commercial applications. In contrast, the enveloping face worm gears of the present invention utilize a worm gear that is easily manufactured.

Rolling motion with small percentage of sliding motion significantly increases efficiency of an enveloping speed reducer. For the same size, this invention has almost twice the torque capacity of traditional spiral bevel or helical gearing. Suction tooth action makes excellent tooth lubrication that also reduces heat. It allows different casting designs from not very heat conductive materials, even from plastic or ceramic. As compared to prior spiral bevel or helical gear speed reducers, enveloping worm face speed reducer is more compact, quiet and efficient. Thus, the present invention can replace bevel, hypoid, or helical gears in many powertrain applications.

In the present invention, the enveloping worm can be with less than one revolution of threads, which can have only one supporting shaft. Further areas of applicability of the present invention will become apparent from the comprehensive description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this complete description.

### BRIEF DESCRIPTION OF THE DRAWINGS

The present invention will become more fully understood from the details described below:

FIG. 1 is an isometric view of a design with less than 180 degree of thread revolution of an enveloping worm pinion placed on the face of a worm gear, where enveloping worm pinion shaft and said face gear shaft are intersected.

FIG. 2 is a top view of a speed reducer with enveloping worm face gears with crossing axes between enveloping worm shaft and face gear shaft according to the principles of the present invention.

FIG. 3 is a side view of a speed reducer with enveloping worm face gears with crossing axes between enveloping worm shaft and face gear shaft according to the principles of the present invention.

FIG. 4 is an isometric view of a design with less than 180 degree of thread revolution of an enveloping worm placed on the face of a worm gear, where enveloping worm pinion shaft and said face gear shaft are parallel.

FIG. 5 is an isometric view of a design with less than 180 degree of thread revolution of an enveloping worm for design, where enveloping worm pinion shaft and said face gear shaft are parallel.

FIG. 6 is a side view of a speed reducer with enveloping worm face gears with parallel axes between enveloping worm pinion shaft and face gear shaft according to the principles of the present invention.

FIG. 7 is a top view of a speed reducer with enveloping worm face gears with crossed axes between enveloping worm pinion shaft and face gear shaft according to the principles of the present invention.

FIG. 8 is a top view of a speed reducer with enveloping worm face gears with crossed axes between enveloping worm pinion shaft and face gear shaft according to the principles of the present invention.

FIG. 9 is a schematic of a gear train as a combination of two pairs of right angle gear sets, where input shaft of a pinion of first pair of sets and an output shaft of second pair of sets are parallel.

FIG. 10 is a schematic of a gear train as a combination of right angle gear set and gear set of parallel shafts, where input shaft of pinion of first pair of sets and an output shaft of second pair of sets are intersected.

FIG. 11 is a schematic of a gear train as a combination of two pairs of parallel shafts' gear sets, where input shaft of a pinion of first pair of sets and an output shaft of second pair of sets are parallel.

FIG. 12 is an isometric view of a gear train as a combination of two pairs of enveloping face worm sets, where enveloping worm pinion shaft of first pair of sets and face gear shaft of second pair of gear sets are parallel.

FIG. 13 is an isometric view of a gear train as a combination of two pairs of enveloping face worm sets, where enveloping worm pinion shaft of first pair of sets and face gear shaft of second pair of gear sets are crossed.

FIG. 14 is an isometric view of a gear train as a combination of two pairs of enveloping face worm sets, where enveloping worm pinion shaft of first pair of sets and face gear shaft of second pair of gear sets are intersected.

### DETAILED DESCRIPTION OF THE PREFERRED EMBODIMENTS

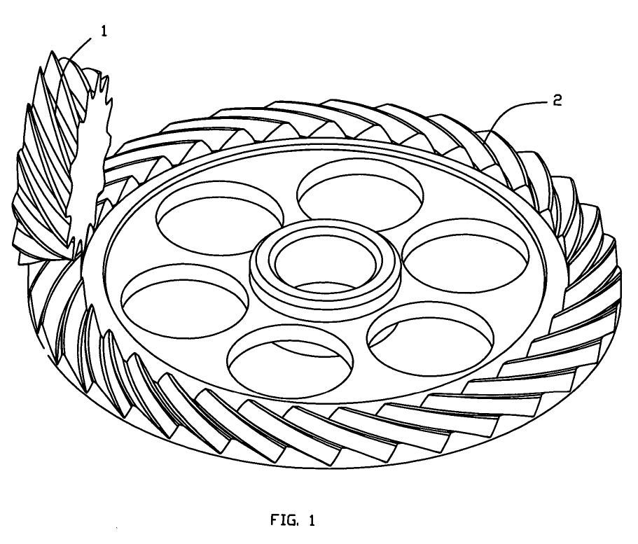

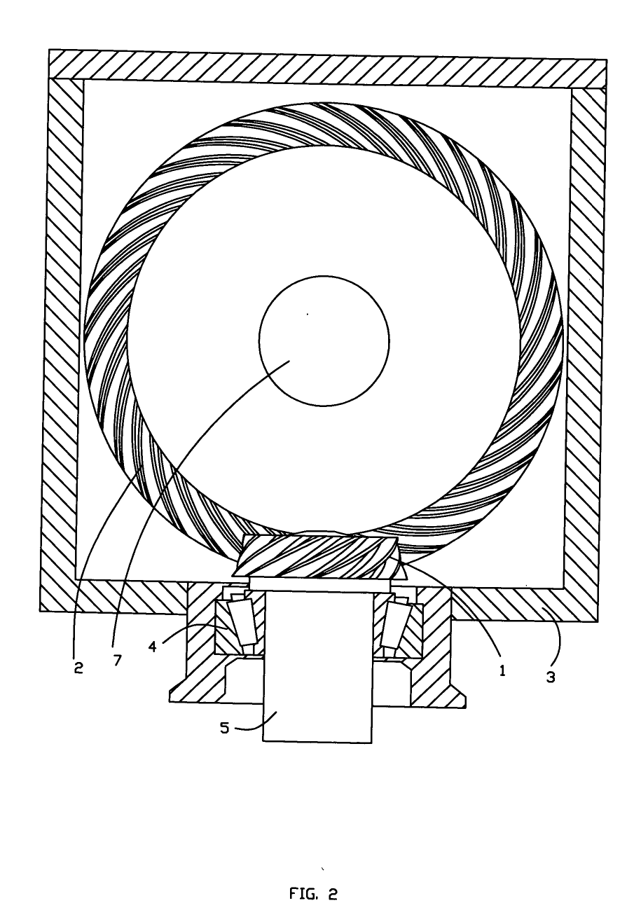

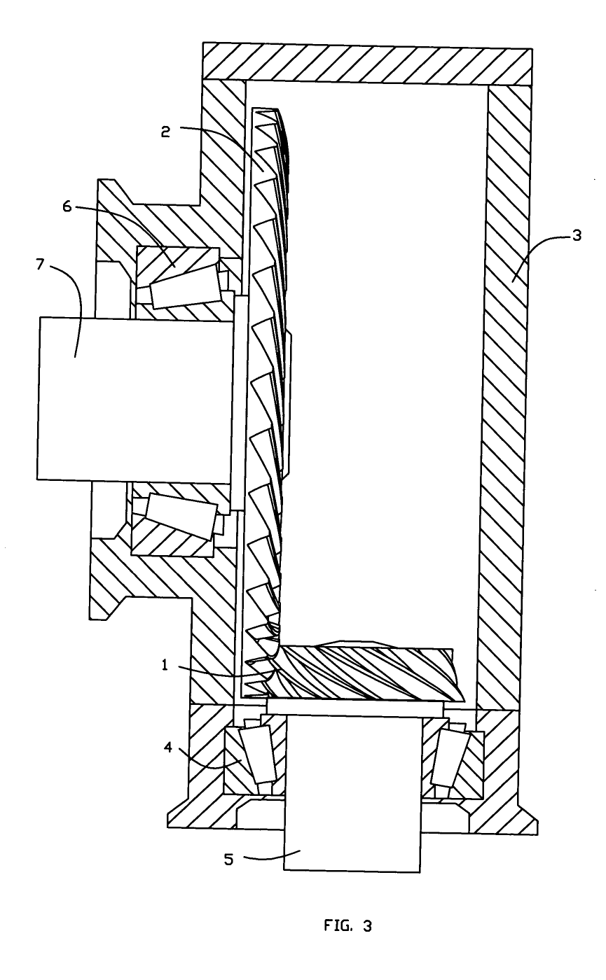

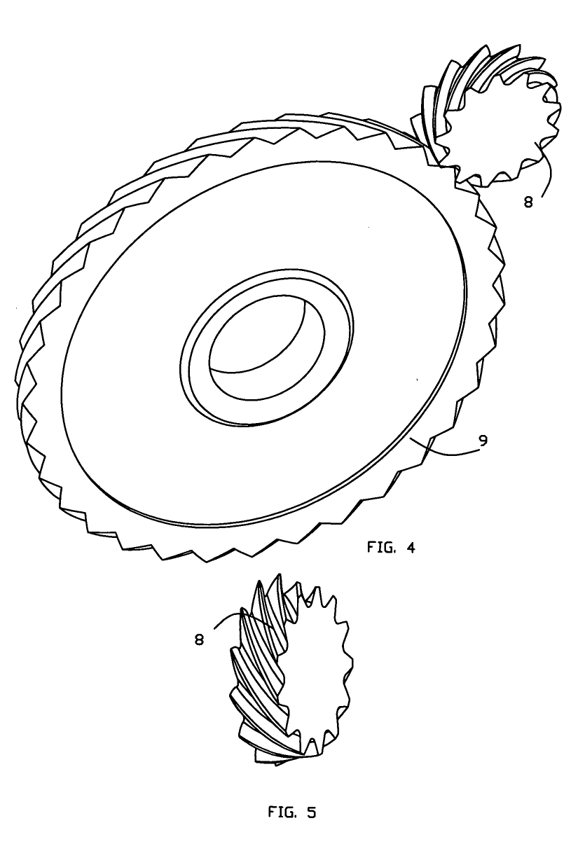

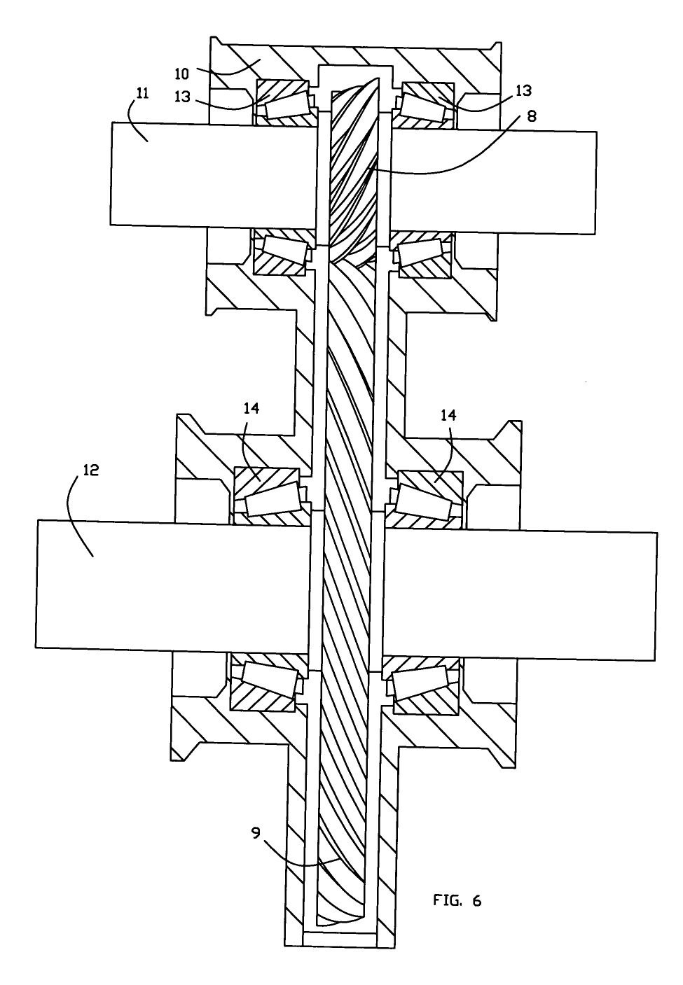

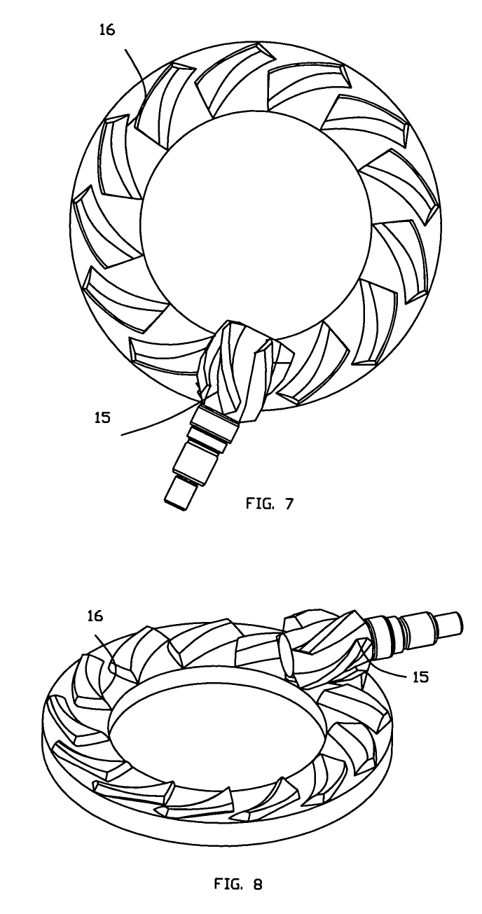

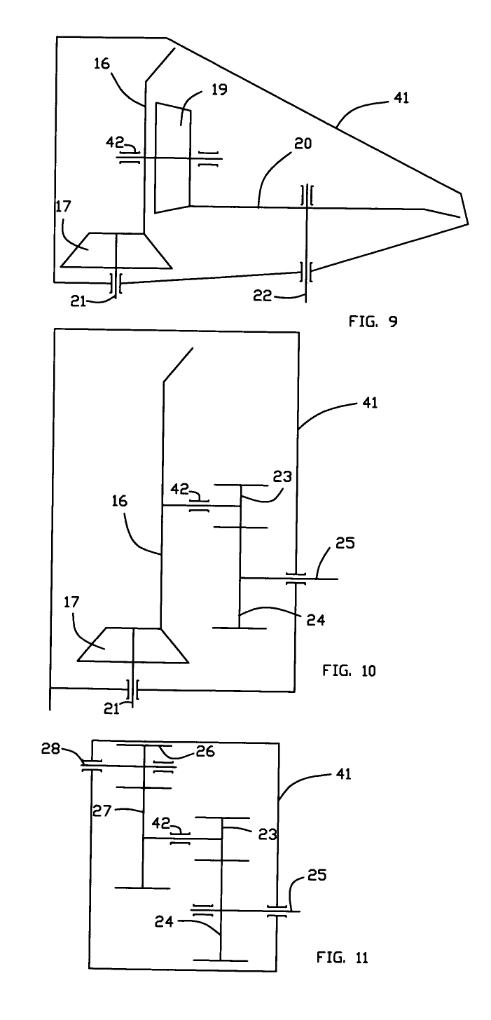

As will be detailed, an enveloping speed reducer with a unique worm-type input gearset embodying the principles of the present invention will be described below with reference to FIGS. 1 through 14. Initially, however, the following discussion provides a complete description of the enveloping worm face gear transmissions used for the worm-type-input gearset. Prior to specific consideration of the drawings, several unique features of the present invention can be discussed. In particular, the present invention is directed to gearsets having an enveloping worm face gear, where an enveloping worm is placed in mesh with a face gear. This type of gear produces contact pattern along the gear tooth line: from the left to the right or from the right to the left depending on the direction of rotation. This motion of contact pattern is very different from motion of contact pattern of any gears, used in drive axle assemble. For example in hypoid or spiral bevel gears contact pattern in motion is across the gear tooth: from the root to the tip or from the tip to the root depending on the direction of rotation.

Usually, face gear has straight side worm engagement in mesh with a face (ring) gear. The reason for using an enveloping worm is more torque capacity. A computer model simulation can be utilized to generate the configuration of the enveloping worm and gear teeth of the face gear. Then gears could be machined using multi-tasking turning center or special machine, like machines that are widely used for spiral bevel, hypoid gear or helical gear production.

Referring now to the drawings:

FIG. 1 is an isometric view of a design with enveloping worm 1 placed in the middle of the face of worm gear 2 with enveloping worm threads having less than 180 degrees of revolution.

FIG. 2 is a top view of a housing 3 with enveloping worm 1 placed in the middle of the face of worm gear 2 with enveloping worm threads having less than 180 degrees of revolution. Bearing 4 provides bearing support for shaft 5 of said enveloping pinion 1.

FIG. 3 is a side view of a housing 3 with enveloping worm 1 placed in the middle of the face of worm gear 2 with enveloping worm threads having less than 180 degrees of revolution. Bearing 4 provides bearing support for shaft 5 of said enveloping pinion 1, and bearing 6 provides bearing support for shaft 7 of said face gear 2.

FIG. 4 is an isometric view of a design with enveloping worm 8 in meshing engagement with the face of worm gear 9 with enveloping worm threads having less than 180 degrees of revolution and axis of enveloping pinion 7 and axis of face gear 8 are parallel.

FIG. 5 is an isometric view of a design with less than 180 degree of thread revolution of an enveloping worm 8 for design, where enveloping worm pinion shaft and said face gear shaft are parallel.

FIG. 6 is a side view of a housing 10 with enveloping worm pinion 8 in meshing engagement with face gear 9 with enveloping worm threads having less than 180 degrees of revolution. Shaft 11 of enveloping worm pinion 8 is parallel to shaft 12 of face gear 9. Bearings 13 provide a bearing support for shaft 10 of said enveloping pinion 8, and bearings 14 provide a bearing support for shaft 12 of said face gear 9.

FIG. 7 is a view of a design with an enveloping worm 15 placed on the face of worm gear 16 with offset and with enveloping worm threads having 90 degrees of revolution.

FIG. 8 is an isometric view of a design with an enveloping worm 15 placed on the face of worm gear 16 with offset and with enveloping worm threads having 90 degrees of revolution.

According with gear train in FIG. 9, where first pair of right angle gear set having pinion 17 in mesh with gear 18 and second pair of right angle gear set having pinion 19 in mesh with gear 20 and at least first or second pair of right angle gear sets is enveloping pinion face gear set. Input shaft 21 of pinion 17 of first pair of sets and an output shaft 22 of second pair of sets are parallel. Gear train in FIG. 10 is a combination of right angle gear set having pinion 17 in mesh with gear 18 and parallel shafts' gear set having gears 23 and 24 in mesh. Right angle gear set or parallel shafts' gear set is enveloping pinion face gear set. Input shaft 21 of pinion 17 and an output shaft 25 of gear 24 are intersected. According with gear train in FIG. 11, first pair of parallel shafts' gear set having gear 27 in mesh with gear 28 and second pair of parallel shafts gear set having gear 23 in mesh with gear 24 and at least first or second pair of parallel shafts' gear sets is enveloping pinion face gear set. Input shaft 28 of a pinion 17 of first pair of sets and an output shaft 25 of second pair of sets are parallel.

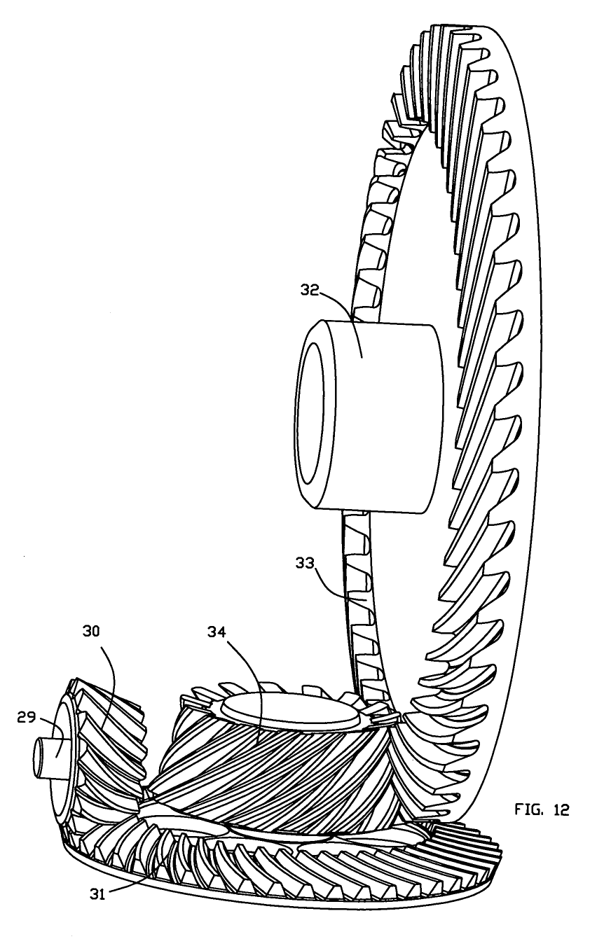

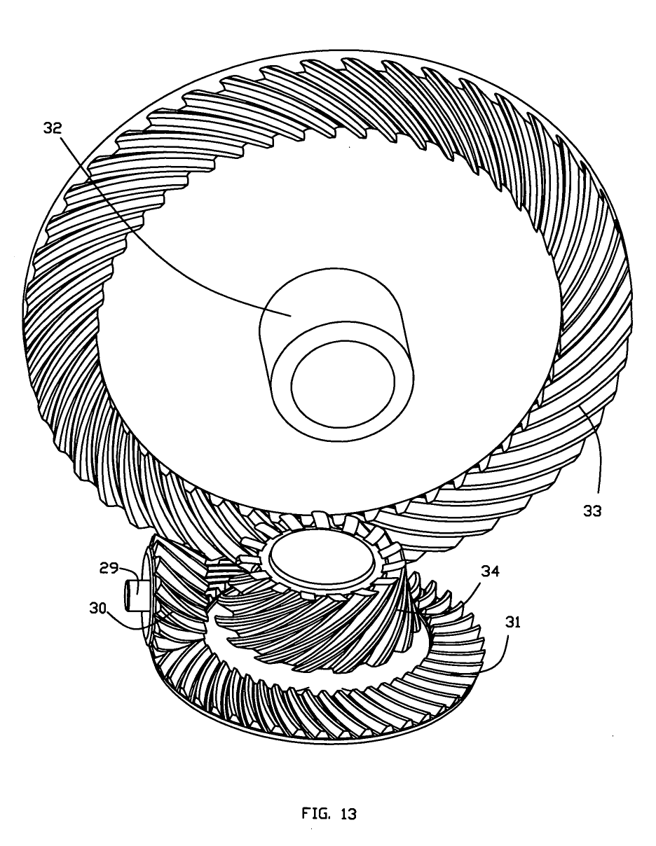

FIG. 12 is an isometric view of a gear train shown in FIG. 9. It has a combination of two pairs of enveloping face worm sets, where shaft 29 of first pair of gears 30 in mesh with gear 31 and shaft 32 of second pair of gears 33 in mesh with gear 34 are parallel.

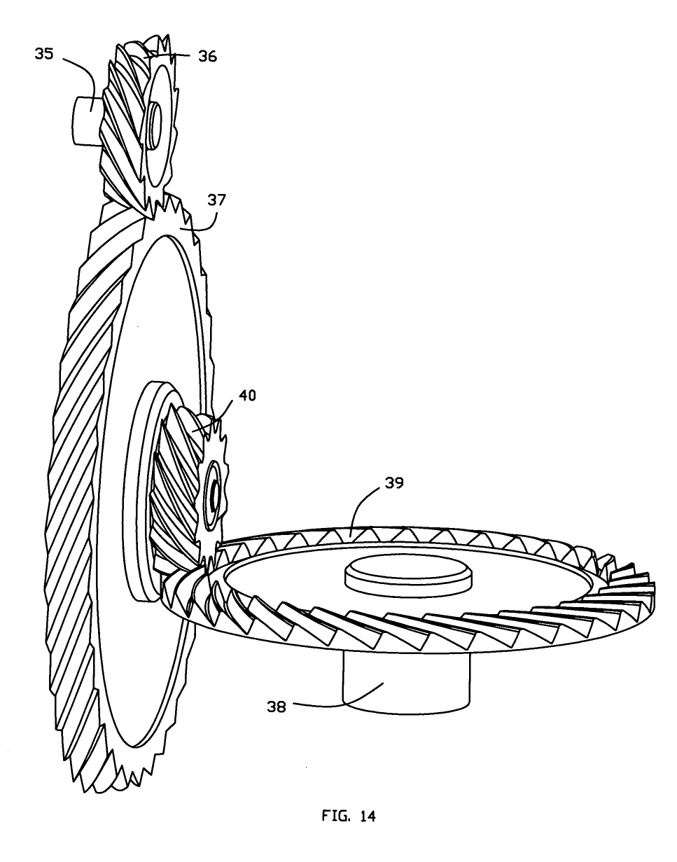

FIG. 13 is the same gear train as shown in FIG. 12, but position of the pinion 30 on the face gear 31 is changed. It makes crossed angle between input shaft 29 and output shaft 32. Combinations of enveloping worm face gears according with FIG. 9-FIG. 14 are used for increasing ratio of speed reducer.

FIG. 14 is an isometric view of a gear train shown in FIG. 10. It has a combination of two pairs of enveloping face worm sets, where shaft 35 of first pair of gears 36 in mesh with gear 37 and shaft 38 of second pair of gears 39 in mesh with gear 40 are parallel.

The shape and material of housing 41 may have many different variations. Bearing support 42 for every design can be calculated according with engineering practice.

New enveloping worm transmission is comprised of worm gear 2 and enveloping worm 1. Worm 1 has at least one screw thread that is engaged by at least one tooth of said worm gear 2 wherein worm gear 2 is a face gear. Enveloping worm pinion 1 is placed into face arrangement with worm gear 2. In this enveloping worm face transmission the enveloping worm could have any design, however, it is preferred that the enveloping worm pinion 1 be relocated to face arrangement with said worm gear 2 from its original position (where it is usually generated for well known double enveloping worm/worm gear transmission). The profile of enveloping worm thread could be produce from mathematical equations, computer simulation or machined by a special program, but it is the same enveloping worm that is used as a pinion for double enveloping gears, where the enveloping worm pinion is placed in the original position in meshing engagement on the top of the worm gear, not on the face of the worm gear. This is a non obvious usage of well known enveloping worm. By repositioning the enveloping worm thread from its original position into face engagement with a worm gear makes the profile of the worm gear very different from profile of the worm gear of double enveloping worm gears. In standard double enveloping gearing each convex surface on one side of the thread becomes the concave surface and each concave surface of another side of the thread becomes the convex surface. In speed reducer the use of shortened threads with only concave surface on the one side of the thread and convex surface on another side of the thread is preferred. The enveloping worm threads with only concave surface on one side and convex surface on another side have less than one revolution. They can have less than 180 degrees of revolutions or even less than 90 degrees of revolutions. Longer worm thread has better contact ratio, but for low kinematics ratios (for example, less than 1:8) it is more difficult to manufacture enveloping worm transmission and even to assemble an enveloping worm with a worm gear. From manufacturing position it is more convenient to have an asymmetric worm thread.

A computer model simulation can be utilized to generate the surface of the worm gear tooth by using enveloping worm pinion profile as a material remover during moving meshing engagement with face gear blank. The worm gear can also be formed using known techniques such as hobbing by using profile of the enveloping worm pinion as a master gear.

The enveloping worm thread has a rolling action contact relationship with the teeth of the face gear, which provides an increased efficiency. In standard double enveloping worm gearing the enveloping worm thread has partially a rolling but mostly sliding action contact relationship with the teeth of the worm gear. In the present application, it is a surface-to-surface contact between the enveloping worm gear teeth and the face gear that increases the torque capacity of the drive axle assemble. For back drive, where the face gear is a driven member and the enveloping worm is a driving member, this speed reducer also has high efficiency compared to a spiral bevel, hypoid or helical gear set.

The lower noise of the enveloping worm face speed reducer gear compared to hypoid, bevel or helical speed reducers makes using the present invention more beneficial in powertrain applications. For the same size, this invention can provide more than twice the capacity of hypoid or helical gearing. The possibility to reduce number of gear teeth of the present invention due to high contact ratio makes each tooth thicker and therefore stronger.

### Advantages of an Enveloping Speed Reducer

Transmit More Power with Smaller Gears.

Compact alternative for speed reducers with hypoid, spiral bevel or helical gears. Enveloping worm face gears have high torque capacity due to surface to surface contact mesh that reduces contact stresses. It saves up to 30% of space and significantly reduces weight.

Efficiency is Extremely High

Hypoid, spiral bevel or helical gears are have always been used in the speed reducers, but enveloping worm face speed reducer is more efficient. It has higher percentage of rolling/sliding motion and excellent dynamic lubrication. It has extended life even without lubrication.

Lower Noise

Each thread of the pinion is in mesh with two teeth most of the time. It reduces impact of engagement and disengagement, increases the contact ratio and makes quieter motion.

Manufacturability

Using existing spiral bevel, hypoid or helical gear cutting machines can make enveloping worm face speed reducer not more expensive than hypoid, spiral bevel or helical gears. For some configuration, forging technology or power metallurgy could be applied as well.

Several embodiments of the present invention have been disclosed. A worker of ordinary skill in the art would recognize that certain modifications would come within the scope of this invention. In the invention being thus described, it will be obvious that the same may be varied in many ways. Such variations are not to be regarded, as a departure from the spirit and scope of the invention, and all such modifications as would be obvious to one skilled in the art are intended to be included within the scope of the following claims.

1. An enveloping speed reducer comprising:
an enveloping worm pinion in meshing engagement with a face type worm gear;
a housing with bearing support for a shaft of said enveloping pinion and a shaft of said face gear;

2. An enveloping speed reducer as recited in claim 1 wherein said enveloping worm pinion shaft and said face gear shaft are intersected.

3. An enveloping speed reducer as recited in claim 1 wherein said enveloping worm pinion shaft and said face gear shaft are crossed.

4. An enveloping speed reducer as recited in claim 1 wherein said enveloping worm pinion shaft and said face gear shaft are parallel.

5. An enveloping speed reducer as recited in claim 1 wherein said enveloping worm pinion has threads with less than one revolution.

6. An enveloping speed reducer as recited in claim 1 wherein said enveloping worm pinion has threads with less than 180 degrees of revolution.

7. An enveloping speed reducer as recited in claim 1 wherein said enveloping worm pinion has threads with convex surface on one working side and concave surface on another working side.

8. An enveloping speed reducer comprising:
a gear train having an enveloping worm in meshing engagement with a face type worm gear that are connected to additional gears;
a housing with bearing support for shafts of said gear train.

9. An enveloping speed reducer as recited in claim 8 wherein an input shaft of said gear train and an output shaft of said gear train are intersected.

10. An enveloping speed reducer as recited in claim 8 wherein an input shaft of said gear train and an output shaft of said gear train are crossed.

11. An enveloping speed reducer as recited in claim 8 wherein an input shaft of said gear train and an output shaft of said gear train are parallel.

12. An enveloping speed reducer as recited in claim 8 wherein said enveloping worm pinion has threads with less than one revolution.

13. An enveloping speed reducer as recited in claim 8 wherein said enveloping worm pinion has threads with less than 180 degrees of revolution.

14. An enveloping speed reducer as recited in claim 8 wherein said enveloping worm pinion has threads with convex surface on one working side and concave surface on opposite working side.

15. An enveloping speed reducer as recited in claim 8 wherein said additional gears of said gear train are enveloping worm in mesh with a face gear.

16. An enveloping speed reducer as recited in claim 8 wherein said additional gears of said gear train are spiral bevel gear pinion in mesh with a spiral bevel ring gear.

17. An enveloping speed reducer as recited in claim 8 wherein said additional gears of said gear train are a pair of helical gears.
